(19) United States
(12) Patent Application Publication
(10) Pub. No.: US 2022/0104511 A1
(43) Pub. Date: Apr. 7, 2022

(54) PRECISELY-SHAPED CHOCOLATE ELEMENTS, CHOCOLATE CONFECTION INCLUDING THE SAME, AND METHODS OF MAKING THE SAME

(71) Applicant: 3M INNOVATIVE PROPERTIES COMPANY, St. Paul, MN (US)

(72) Inventor: Anatoly Z. Rosenflanz, Maplewood, MN (US)

(21) Appl. No.: 17/472,219

(22) Filed: Sep. 10, 2021

Related U.S. Application Data
(60) Provisional application No. 63/086,423, filed on Oct. 1, 2020.

(51) Int. Cl. A23G 1/54; A23G 1/48

(52) U.S. Cl. CPC A23G 1/545; A23V 2002/00; A23G 1/48

(57) ABSTRACT

A chocolate confection comprises precisely-shaped chocolate elements bonded together at points of contact to form a porous mass having a porosity of at least 40 percent; and an edible substance disposed within the porous mass. Precisely-shaped chocolate elements, each independently have a maximum dimension of less than or equal to 3 millimeters and an aspect ratio of 3:1 to 10:1. Methods of making the precisely-shaped chocolate elements and chocolate confection are also disclosed.

### CROSS-REFERENCE TO RELATED APPLICATION

This application claims priority from U.S. Provisional Application Ser. No. 63/086,423, filed Oct. 1, 2020, the disclosure of which is incorporated by reference in its entirety herein.

### TECHNICAL FIELD

The present disclosure broadly relates to confections and methods of making them.

### BACKGROUND

Chocolate is made from cacao beans (sometime called seeds) from the Theobroma cacao tree. This plant produces large, pod-like fruits, each containing 20-60 beans surrounded by a sticky, sweet tart white pulp. The contents of the beans provide the basis for chocolate products. Once cacao beans are harvested, they go through several processing steps:

Fermentation: The beans (with some sticky pulp still clinging on) are put into bins and covered for a few days so microbes that feed on the pulp can ferment the beans. This starts to develop the distinctive chocolate flavor and aroma.

Drying: The fermented beans are dried for several days. Once dry, they may be sorted and sold to chocolate makers.

Roasting: The dried beans are roasted unless a raw product is desired. Roasting more fully develops the chocolate flavor and gives them some sweetness.

Crushing: The beans are crushed and separated from their outer hulls, resulting in broken cacao pieces called nibs.

Grinding: Nibs are ground, producing a non-alcoholic liquor containing cocoa solids and cocoa butter. Now it's ready to be made into chocolate products.

To make cocoa powder, the liquor, which is roughly half fat in the form of cocoa butter, is pressed to remove most of the fat. To make chocolates other than white chocolate, the liquor is often mixed with other ingredients, including vanilla, sugar, more cocoa butter and milk. White chocolate is a chocolate confection made from cocoa butter, sugar and milk solids. White chocolate does not contain cocoa solids, which are found in other types of chocolate.

Various filled chocolate confections are commercially available with a chocolate outer shell enclosing a sweet filling. Examples include chocolate cordials and chocolate covered jellies.

### SUMMARY

In order to experience the full flavor of such filled chocolate confections it is necessary to bite through the outer chocolate shell. It would be desirable to be able to experience the flavors of the chocolate and the filling as a melt-in-the-mouth chocolate confection without having to bite into the confection.

In one aspect, the present disclosure provides a chocolate confection comprising:

precisely-shaped chocolate elements, each independently having a maximum dimension of less than or equal to 3 millimeters and an aspect ratio of 3:1 to 10:1, bonded together at points of contact to form a porous mass having a porosity of at least 40 percent; and

an edible substance disposed within the porous mass.

In another aspect, the present disclosure provides a method of making a chocolate confection comprising:

bonding precisely-shaped chocolate elements, each independently having a maximum dimension of less than or equal to 3 millimeters and an aspect ratio of 3:1 to 10:1, together at points of contact to form a porous mass having a porosity of at least 40 percent; and

infusing an edible substance into the porous mass.

In yet another aspect, the present disclosure provides precisely-shaped chocolate elements having a maximum dimension of less than or equal to 3 millimeters and an aspect ratio of 3:1 to 10:1. These precisely-shaped chocolate elements are used to make chocolate confections according to the present disclosure.

As used herein, the term “chocolate” includes white chocolate, milk chocolate, dark chocolate, and any other type of processed chocolate containing cocoa butter and/or cocoa solids form.

As used herein, the term “precisely-shaped” in reference to chocolate elements or mold cavities used to make them refers to chocolate elements or cavities having three-dimensional shapes that are defined by relatively smooth-surfaced sides that are bounded and joined by well-defined sharp edges having distinct edge lengths with distinct endpoints defined by the intersections of the various sides. Random minor manufacturing irregularities (e.g., mold overfill flash and voids) are permissible within the meaning of this definition.

Features and advantages of the present disclosure will be further understood upon consideration of the detailed description as well as the appended claims.

### BRIEF DESCRIPTION OF THE DRAWINGS

FIG. 1 is a perspective side view of exemplary chocolate confection 100 according to the present disclosure.

FIG. 1A is an enlarged view of region 1A in FIG. 1.

FIG. 2 is a perspective side view of exemplary porous mass 120.

FIG. 3A is a top view of exemplary chocolate element 110.

FIG. 3B is a side view of exemplary chocolate element 110.

It should be understood that numerous other modifications and embodiments can be devised by those skilled in the art, which fall within the scope and spirit of the principles of the disclosure. The figures may not be drawn to scale.

### DESCRIPTION

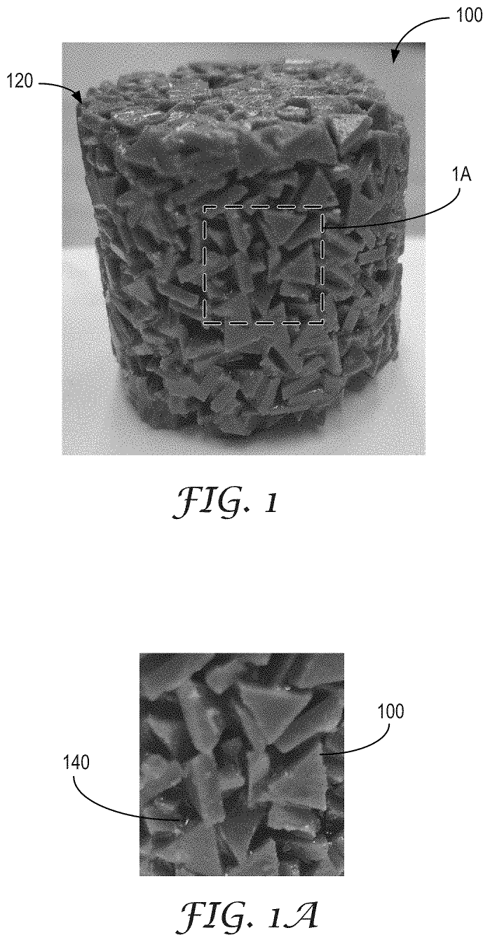

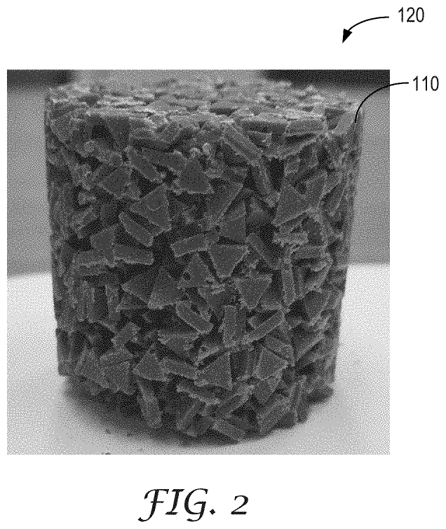

Referring now to FIGS. 1 and 1A, exemplary chocolate confection 100 comprises precisely-shaped chocolate elements 110. Chocolate elements 110 are bonded at points of mutual contact to form porous mass 120 (shown in isolation in FIG. 2) with a porosity of at least 40 percent. Edible substance 140 is disposed within porous mass 120. The edible substance may occupy any or all of the void space within the porous mass. Typically, the edible substance is confined with in the porous mass, but is some embodiments, it may extend beyond the interior of the porous mass and may also coat some or all of the outer surface of the porous mass.

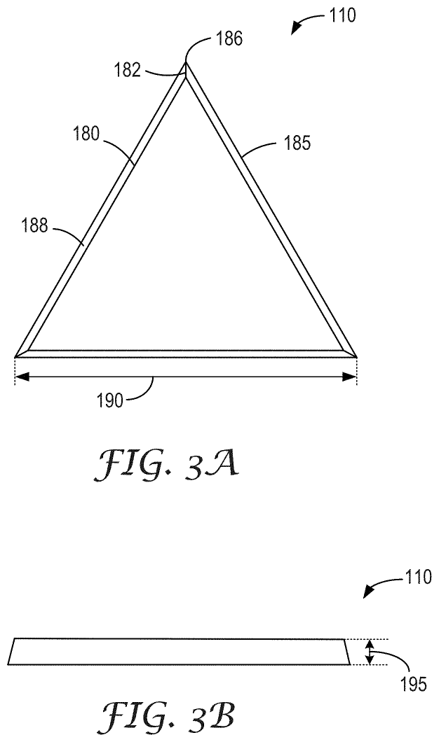

Referring now to FIGS. 3A and 3B, each precisely-shaped chocolate element 110 independently has a top surface 180, a bottom surface 185, sidewalls 188, a length 190, and a thickness 195. Edges 182 and points 186 are formed by intersection of the top surface, bottom surface, and/or sidewall(s). Length 190 is less than or equal to 3 millimeters. In some cases, less than or equal to 2 mm, less than or equal to 1 mm, less than or equal to 0.5 mm, less than or equal to 0.3 mm, or less than less than or equal to 0.1 mm. Each precisely-shaped chocolate element 110 independently has an aspect ratio (i.e., length 190 divided by thickness 195) of 3:1 to 10:1.

While FIGS. 3A and 3B depict a precisely-shaped chocolate element shaped as a truncated pyramid with sloping sidewalls, precisely-shaped chocolate elements according to the present disclosure may have non-sloping sidewalls. Further, useful precisely-shaped chocolate elements may have four, five, or even six sides, for example, with sloping or non-sloping sidewalls. Preferably, the precisely-shaped chocolate elements have the form of platelets having at least three sidewalls. Preferably, the sidewalls of the precisely-shaped chocolate elements have the same dimensions; however, this is not a requirement.

The precisely-shaped chocolate elements used to form the porous mass may all have the same composition, or they may comprise a mixture of precisely-shaped chocolate elements having various compositions (e.g., white chocolate and dark chocolate), sizes, and/or shapes (e.g., triangular platelets mixed with square platelets).

Precisely-shaped chocolate elements can be readily fabricated using microreplication technology drawn from the unrelated field of abrasives manufacturing. In short, the method relies on forming an engraved master tool (e.g., a nickel-coated metal roll) which is then used to form (e.g., by embossing or melt-molding) a production tool (e.g., made of food grade polypropylene or polyethylene) that is an inverse of the master tool having precisely-shaped mold cavities corresponding in shape to the precisely-shaped chocolate elements. Filling the mold cavities and removing any overfill with molten chocolate is followed by solidifying the chocolate by cooling to room temperature or below, preferably less than 10° C., or even less than 0° C. Next, the precisely-shaped chocolate elements are removed from the mold by agitation, which may be assisted by ultrasonic vibration, for example.

Details concerning manufacture and use of such molds having precisely-shaped miniature cavities can be found, for example, in U.S. Pat. Appl. Publ. No. 2010/146867 A1 (Adefris et al.).

To form the porous body, a mold is loosely filled with a plurality of the precisely-shaped chocolate elements. In typical embodiments, at least 50, preferably at least 100 precisely-shaped chocolate elements are used, although this is not a requirement. The precisely-shaped chocolate elements are then bonded to one another at points of contact resulting a porous mass. Bonding is conveniently achieved by application of light pressure in many cases, although sintering, and/or ultrasonic bonding may also be useful. Preferably, the porous mass has a substantially continuous, preferably continuous network of pores extending throughout the porous mass. The porous body may have any porosity greater than or equal to 40 percent; for example, at least 50 percent, at least 55 percent, or even at least 59 percent. Preferably, the porous body will have a porosity of 40 to 59 percent.

The porous mass generally has sufficiently integrity at this point that it can be handled separately if removed from the mold, although this is not a requirement. For example, infusion of the edible substance, in flowable form as an edible flowable substance, may take place after removal of the porous body from the mold or while it is still retained within the mold. Infusion of the edible flowable substance may be accomplished by any suitable means including, for example, by submersing of the porous body in the edible flowable substance or by dispensing the edible flowable substance onto/into the porous body (after removal from the mold or while it is still retained in the mold).

Useful edible flowable substances can be any edible substance that is flowable below the softening/melting point(s) of the chocolate elements and can be substantially retained within the porous mass after infusion. In some embodiments, the edible substance is a gel or solid at room temperature (68-72° F. (20-22° C.)); e.g., if cooled after infusion into the porous mass. Examples of suitable edible flowable substances include jams (e.g., fruit jam), jellies (e.g., fruit jellies), honey, syrups (including fruit syrups, maple syrups, and flavored or unflavored corn syrups), chocolate (if lower melting than the porous mass), puddings, flavored gelatins, molasses, and combinations thereof. The edible flowable substance may contain at least one edible rheology modifier such as, for example, a thickener or a thixotrope.

Optionally, the chocolate confection may further include an outer coating which may provide flavor an/or handleability. Exemplary outer coatings include nuts, powdered sugar, and coconut flakes.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Example 1

About 200 g of Nestle chocolate chips were melted in a stainless steel bowl placed in a vessel containing heated water. The melted chocolate was a smooth flowable paste. The paste was applied with a squeegee to polypropylene production tools having truncated triangular pyramidal cavities with a nominal draft angle of 8 degrees (or 98 degrees depending on convention), a nominal side length of 1.8 mm, and a nominal thickness of 0.45 mm. The chocolate in the mold cavities was then cooled to room temperature, shaped chocolate particles were removed by shaking the production tool and in some cases application of ultrasonic vibration to the back side of the production tool.

The resulting precisely-shaped chocolate elements were examined using conventional SEM (scanning electron microscopy). Edge widths and corner radius values were measured and were found to range from about 8 to 15 mic and 4 to 12 mic respectively.

Bulk density of precisely-shaped chocolate elements was measured using a standard method involving determination of mass and volume (using graduated cylinder). Typical bulk density was found to be around 0.55-0.6 g/cm³. Theoretical density of chocolate elements was measured using standard He pycnometry method using Accupyc II (Micromeritics, Norcross, Ga.) instrument. For chocolate elements described above theoretical density was found to be around 1.32 g/cm³. In this way a porosity of loose powder composed of precisely shaped chocolate elements is estimated to be around 55 to 60%.

About 10 g of the precisely shaped chocolate elements were placed in a human mouth. The taste perception could be described as: immediate intense taste of short duration. 10 g of the Nestle chocolate chips were placed in a mouth as a comparison. Taste perception could be described as: delayed, not as intense, taste of longer duration. The present inventor believes that the difference may be related at least on part to higher geometric surface area in the case of the precisely-shaped chocolate elements which led to “faster” interaction with taste buds. However, without wishing to be bound by theory, the present inventor also believes that the enhanced immediate flavor intensity may be due in part to sharp features (points and/or edges formed by intersection of the side walls and the top or bottom surfaces) of the precisely-shaped chocolate elements. Particle size distributions having a D₉₀ of less than 40 microns are generally associated with perception of grittiness and lower quality of chocolates. These particle size ranges are generally comparable to typical edge sharpness of the precisely shaped chocolate elements used in the examples hereinbelow. Advantageously, this presents the opportunity to change the taste perception of chocolate and chocolate confections through manipulation of shape alone.

### Example 2

About 7 g of the precisely-shaped chocolate elements prepared as described in Example 1 were placed in a 1-inch (2.54-cm) diameter stainless steel die and uniaxially pressed at a nominal pressure of 0.1 MPa. A free-standing porous mass was obtained generally having the appearance shown in FIG. 2. Porosity of the article was found to be around 53% (it was measured as described above, i.e., by measuring bulk density and theoretical density of the article and chocolate elements respectively). The porous mass was placed in a tray containing lightly heated raspberry jam. The flowable jam infused throughout the porous mass and was cooled to provide a chocolate confection according to the present disclosure.

### Example 3

A porous mass, shown in FIG. 2 was prepared as described in Example 2. The porous mass was infused with liquid gelatin prepared by dissolving one 6 oz (0.17 kg) package of “Essential Everyday” Gelatin Dessert package in 2 cups of boiling water followed by addition of 2 cups of cold water to provide the chocolate confection shown in FIG. 1. After infusion the infused article was allowed cool which caused the gelatin mass to solidify.

The preceding description, given in order to enable one of ordinary skill in the art to practice the claimed disclosure, is not to be construed as limiting the scope of the disclosure, which is defined by the claims and all equivalents thereto.

What is claimed is:

1. A chocolate confection comprising:
precisely-shaped chocolate elements, each independently having a maximum dimension of less than or equal to 3 millimeters and an aspect ratio of 3:1 to 10:1, bonded together at points of contact to form a porous mass having a porosity of at least 40 percent; and
an edible substance disposed within the porous mass.

2. The chocolate confection of claim 1, wherein the precisely-shaped chocolate elements comprise cocoa solids.

3. The chocolate confection of claim 1, wherein the precisely-shaped chocolate elements are free of cocoa solids.

4. The chocolate confection of claim 1, wherein the edible substance comprises a fruit-flavored edible material.

5. The chocolate confection of claim 4, wherein the edible substance comprises a fruit jam or fruit jelly.

6. The chocolate confection of claim 1, wherein the precisely-shaped chocolate elements are shaped as triangular platelets.

7. The chocolate confection of claim 6, wherein the triangular platelets have sloping sidewalls.

8. The chocolate confection of claim 1, wherein the chocolate confection has a porosity of 5 percent or less.

9. A method of making a chocolate confection comprising:
bonding precisely-shaped chocolate elements, each independently having a maximum dimension of less than or equal to 3 millimeters and an aspect ratio of 3:1 to 10:1, together at points of contact to form a porous mass having a porosity of at least 40 percent; and
infusing an edible flowable substance into the porous mass.

10. The method of claim 9, further comprising at least one of solidifying or gelling the infused edible flowable substance.

11. The method of claim 9, wherein the chocolate confection has a porosity of 5 percent or less.

12. Precisely-shaped chocolate elements having a maximum dimension of less than or equal to 3 millimeters and an aspect ratio of 3:1 to 10:1.

13. The precisely-shaped chocolate elements of claim 12, wherein the precisely-shaped chocolate elements are shaped as triangular platelets.

14. The precisely-shaped chocolate elements of claim 13, wherein the triangular platelets have sloping sidewalls.

15. The precisely-shaped chocolate elements of claim 12, wherein the precisely-shaped chocolate elements comprise cocoa solids.

16. The precisely-shaped chocolate elements of claim 12, wherein the precisely-shaped chocolate elements are free of cocoa solids.
